(19) United States
(12) Patent Application Publication
(10) Pub. No.: US 2017/0349383 A1
(43) Pub. Date: Dec. 7, 2017

(54) DIVERTING CONVEYOR USING A DIVERTING BELT WITH ACTUATED ROLLERS

(71) Applicant: Laitram, L.L.C., Harahan, LA (US)

(72) Inventors: David Herbert Myers, River Ridge, LA (US); Christopher J. Gatz, Jeffersonville, IN (US)

(21) Appl. No.: 15/684,436

(22) Filed: Aug. 23, 2017

Related U.S. Application Data
(63) Continuation-in-part of application No. PCT/US2017/021998, filed on Mar. 13, 2017.
(60) Provisional application No. 62/314,458, filed on Mar. 29, 2016.

(51) Int. Cl. B65G 47/64; B65G 47/51; B65G 43/08; B65G 47/54; B65G 47/82; B65G 47/94

(52) U.S. Cl. CPC B65G 47/642; B65G 47/82; B65G 47/945; B65G 43/08; B65G 47/54; B65G 47/5104; B65G 2203/042

(57) ABSTRACT

A conveyor system with a diverting conveyor belt crossing and intersecting a main conveyor line. The diverting conveyor belt has rollers on its outer side that rotate freely in the main conveying direction of the line. The downstream edge of the diverting conveyor is selectably tilted between a lowered, untilted position level with the main conveyor line and a raised, tilted position above the level of the main conveyor line. When the diverting belt is untilted and stopped, an article passes over the belt's rollers without being diverted. When the diverting belt is tilted and running, it diverts articles off the side of the conveyor line. In another version the rollers include an electrically conductive or magnetic material. A linear-motor stator under the diverting belt selectively actuates the conductive or magnetic rollers to draw undiverted articles across the belt.

### CROSS-REFERENCE TO RELATED APPLICATIONS

This application is a continuation-in-part of International Patent Application No. PCT/US2017/021998, filed Mar. 13, 2017, which claims the benefit of U.S. Provisional Patent Application No. 62/314,458, filed Mar. 29, 2016. The disclosures of those applications are incorporated into this application by reference.

### BACKGROUND

The invention relates to power-driven conveyors and more particularly to conveyor lines intersected by diverting belts with linear-motor-actuated rollers.

A tire-sorting conveyor system using a roller-top conveyor belt crossing and intersecting a conveyor line to selectively sort tires off either side of the line is disclosed in U.S. Pat. No. 7,306,086, which issued on Dec. 11, 2007. The roller-top belt is selectively started and stopped. When running, the belt travels in a direction of belt travel perpendicular to the length of the conveyor line. The rollers in the belt are freely rotatable on axles parallel to the direction of travel of the belt. Tires that are not to be sorted off the conveyor line transfer across the stopped roller-top belt from the upstream portion of the conveyor line to the downstream portion. When a tire that is to be sorted off the conveyor line is received on the running roller-top belt, an actuator raises the belt above the plane of the conveyor line so that the tire is supported only by the belt, which can then sort the tire off a side of the line. But problems can arise if the actuator raises the roller-top belt before a tire reaches the belt. If that occurs, the tire will be blocked by the belt and will not be sorted off. Sensors along the conveyor line are used to indicate that a tire is in position for the belt to be raised. But the timing of the raising of the belt is important in preventing premature raising that can block tires and tardy raising that can cause tires to cross the roller-top belt without being sorted off the side of the conveyor line.

### SUMMARY

A conveyor system embodying features of the invention comprises a main conveyor line having an infeed portion and an outfeed portion and conveying articles in a conveying direction and a diverting conveyor belt intersecting the main conveyor line between the infeed portion and the outfeed portion. The diverting conveyor belt, which is advanceable in a diverting direction transverse to the conveying direction, includes an upstream edge adjacent the infeed portion, an opposite downstream edge adjacent the outfeed portion, and an outer side. Article-supporting rollers protrude from the outer side of the belt and include electrically conductive or magnetic material. The rollers are arranged to rotate in the conveying direction. A linear-motor stator disposed under the diverting conveyor belt produces an electromagnetic wave that interacts with the rollers to actuate the rollers to rotate in the conveying direction. A controller selectively advances the diverting conveyor belt in the diverting direction and unpowers the linear-motor stator to deactuate the rollers and divert articles from the main conveyor line and stops the diverting conveyor belt and powers the linear-motor stator to actuate the rollers to rotate in the conveying direction to transfer articles across the diverting conveyor belt from the infeed portion to the outfeed portion.

### BRIEF DESCRIPTION OF THE DRAWINGS

FIG. 1 is an isometric view, partly cut away, of a conveyor system embodying features of the invention;

FIG. 2 is a side elevation view, partly cut away, of the conveyor system of FIG. 1;

FIG. 3 is a top plan view of the conveyor system of FIG. 1;

FIG. 4 is a cross section of the conveyor system of FIG. 1 taken along lines 4-4 of FIG. 3;

FIGS. 5A and 5B are cross sections of the conveyor system of FIG. 1 taken along lines 5-5 of FIG. 3 showing the diverting conveyor belt in pass-through and tilted diverting positions;

FIG. 6 is a block diagram of a control system for the conveyor system of FIG. 1;

FIG. 7 is a flowchart of a programmed control routine executed by the controller of FIG. 6; and

FIGS. 8A-8C are top plan, front elevation, and side elevation views of a portion of a conveyor system as in FIG. 1 with linear-motor-driven rollers in the diverting belt.

### DETAILED DESCRIPTION

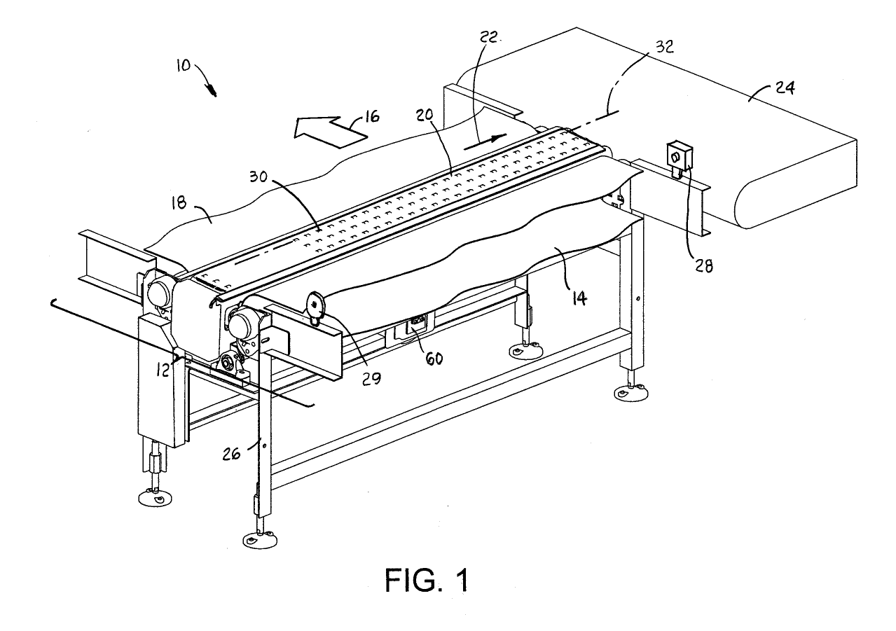

A sorting conveyor system embodying features of the invention is shown in FIG. 1. The conveyor system 10 comprises a main conveyor line 12 having an upstream infeed portion 14 conveying articles in a main conveying direction 16 toward a downstream outfeed portion 18. Crossing and intersecting the main conveyor line 12 is a roller-top conveyor belt 20. The roller-top belt 20 advances in a direction of belt travel 22 transverse—perpendicular in this example—to the main conveying direction 16 to selectively divert articles off the side of the main conveyor 12 and onto a discharge conveyor 24. Articles not diverted off onto the discharge conveyor 24 transfer across the diverting roller-top belt 20 from the upstream portion 14 to the downstream portion 18 of the conveyor line 12. Although the infeed, outfeed, and discharge conveyors 14, 18, 24 are shown as conveyor belts, each could alternatively be realized as a roller conveyor or a chute. And although the main conveyor line is represented as a pair of belts forming the upstream 14 and downstream 18 portions, the main conveyor line could alternatively be constructed of a single conveyor belt whose path detours under the roller-top belt 20. The roller-top belt 20 and the main conveyor line 12 are supported in a frame 26. A position sensor, such as an optical transmitter 28 and receiver 29 (or transmitter/receiver 28 and reflector 29) mounted on the frame 26 on the upstream infeed portion 14 of the conveyor line 12, senses the presence of an article at that position along the length of the line.

The roller-top belt 20 has rollers 30 mounted on axles that define axes of rotation 32 parallel to the direction of belt travel 22. The rollers 30 are freely rotatable in the main conveying direction 16 of the conveyor line 12. With the level of the tops of the rollers 30 at about the level of the plane of the infeed and outfeed conveyor portions 14, 18, articles conveyed down the conveyor line 12 ride the rollers across the roller-top belt 20 to the outfeed portion of the line without being diverted onto the discharge conveyor 24.

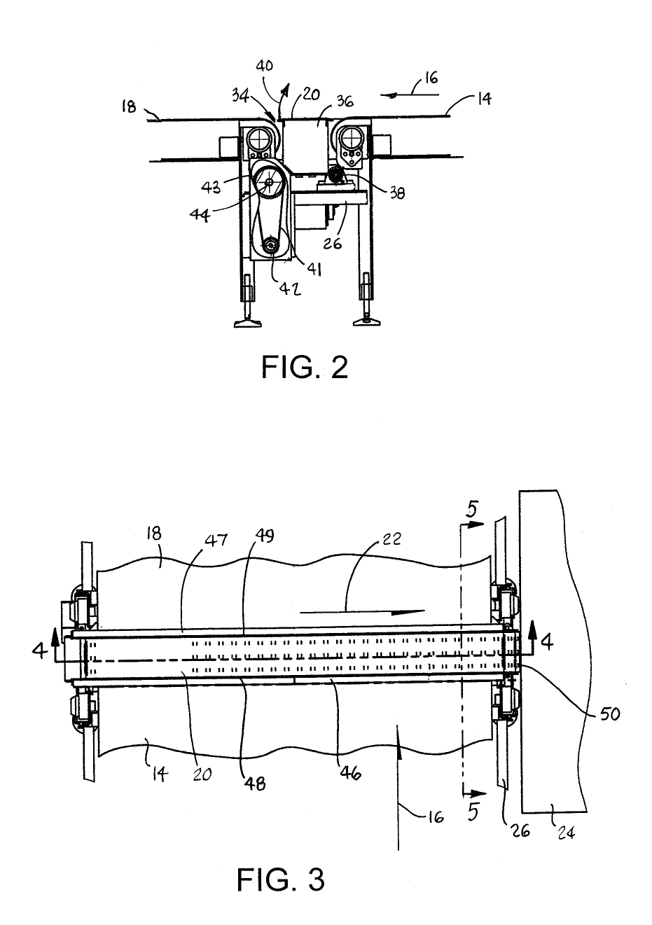

As shown in FIG. 2, the roller-top belt 20 is supported in a gap 34 between the upstream and downstream portions 14, 18 of the main conveyor line. A belt support 36 is pivotably mounted to the conveyor frame 26 at a pivot 38 at the upstream end of the support. The pivot 38 includes a pivot bar that extends across the width of the main conveyor line. The pivot allows the downstream end of the roller-top belt 20 to tilt upward as indicated by the clockwise arrow 40. A motor-driven timing belt 41 trained around two toothed pulleys 42, 43 is used to drive an eccentric camshaft 44 that tilts the roller-top belt's support 36 in one version of a tilt actuator for the sorter belt 20.

FIG. 3 shows a diverting roller-top belt 20 intersecting and crossing the conveyor line between the infeed and outfeed portions 14, 18. The belt support 36 has an overhanging upstream lip 46 between the upstream edge 48 of the belt 20 and the upstream conveyor portion 14 to minimize the gap over which articles must pass in transferring onto the roller-top belt. The support 36 has a similar downstream lip 47 at the downstream edge 49 of the roller-top belt 20. The end 50 of the sorter belt 20 extends past the conveyor frame 26 in close proximity to the discharge conveyor 24.

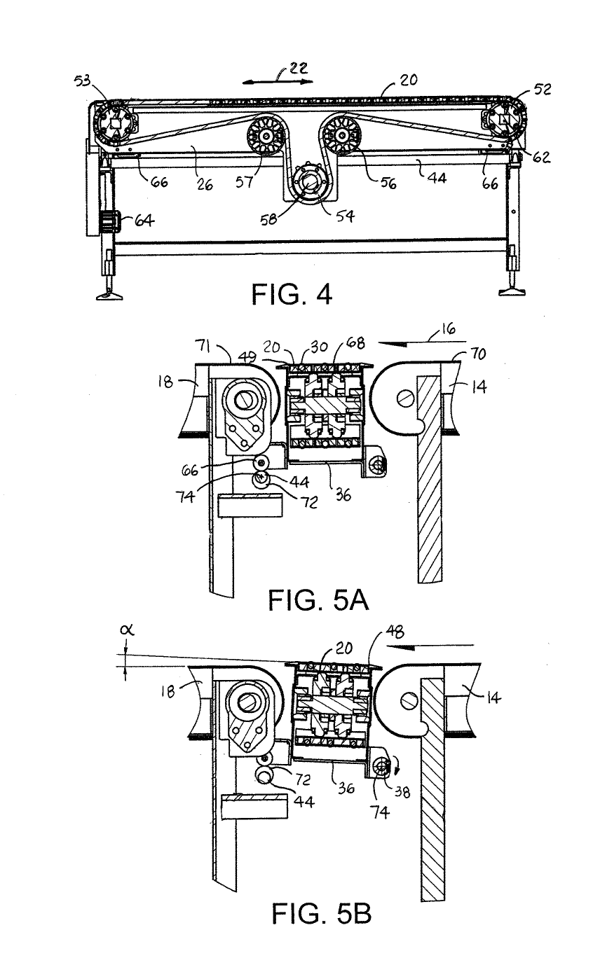

The roller-top belt 20 is shown in FIG. 4 as a center-driven, bidirectional belt. The belt 20 is trained around idle sprocket sets 52, 53 at opposite ends of the belt run. A drive sprocket set 54 and snubber rollers 56, 57 engage the belt 20 in the lower run. The drive sprocket is mounted on a drive shaft 58 driven by a motor (60, FIG. 1). Alternatively, the belt could be driven in only one direction if all sorting is to one side as in FIG. 1. In that case the belt 20 need not be center-driven. Instead, the drive motor could be connected to the shaft 62 of the sprocket set 52 closer to the discharge end of the belt, and the center-drive sprocket set 54 and snubber rollers 56, 57 could be replaced with support rollers or shoes in the lower belt-return run. FIG. 4 also shows a servomotor 64 whose shaft is coupled to the lower pulley 42 (FIG. 2) that drives the timing belt 41 (FIG. 2) in the sorter-belt tilt actuator. The tilt actuator's eccentric camshaft 44 is elongated in the direction of travel 22, i.e., the diverting direction. Cam followers 66 mounted at opposite ends of the belt support 26 ride on the camshaft 44.

Other details of the tilt actuator are shown in FIGS. 5A and 5B in connection with a description of the operation of the sorter. The belt support 36 is shown in FIG. 5A in a pass-through position, in which the tops of the rollers 30 at the upper outer side 68 of the belt 20 are generally coplanar with the conveying surfaces 70, 71 of the infeed and outfeed conveyors 14, 18. The eccentric camshaft 44 forms a lobe 72 that is in a downward position relative to the shaft's axis 74 to lower the belt support 36 to the level, pass-through position. When the cam followers 66, which are mounted to the belt support 36 below the downstream edge 49 of the diverting belt 20, sit on the non-lobe portion of the camshaft 44, the belt is not tilted relative to the conveyor line. With the belt 20 in that position, articles transfer across the freely rotatable rollers 30 from the upstream conveyor portion 14 to the downstream portion 18 without being diverted. When the roller-top belt 20 is in the untilted position, it is also typically stopped. In that way there is no sidewise force applied to the articles, and they pass directly across on the stationary and freely rotatable belt rollers 30.

Just before an article selected to be diverted off the side of the conveyor line reaches the diverting conveyor belt 20, a controller sends a tilt signal to the servomotor (64, FIG. 4) to drive the tilt actuator's timing belt (41, FIG. 2) to rotate the upper pulley (43, FIG. 2) and the camshaft 44 180° . The cam follower 66 is lifted by the rotating camshaft 44 until the timing belt stops with the cam lobe 72 facing upward as shown in FIG. 5B. The cam follower's movement on the eccentric camshaft 44 pivots the belt support 36 on the pivot bar 38 about a pivot axis 74 parallel to the diverting direction (into the page in FIG. 5B). The pivot bar 38 resides below the upstream edge 48 of the roller top belt 20. With the cam lobe 72 facing up, the roller-top belt 20 is at a maximum tilt angle α of 30° or less relative to the plane of the infeed and outfeed conveyors 14, 18. When the roller-top belt 12 is in the tilted, diverting position, it is also driven in the diverting direction (into the page is FIG. 5B). Articles selected for diverting are prevented from contacting the outfeed conveyor portion 18 and are diverted off the side of the conveyor line by the tilted diverter belt 20. If the next article is not to be diverted, the servomotor precisely advances or reverses the camshaft 44 another 180° until the cam lobe is downward as in FIG. 5A, and the belt motor (60, FIG. 1) is stopped.

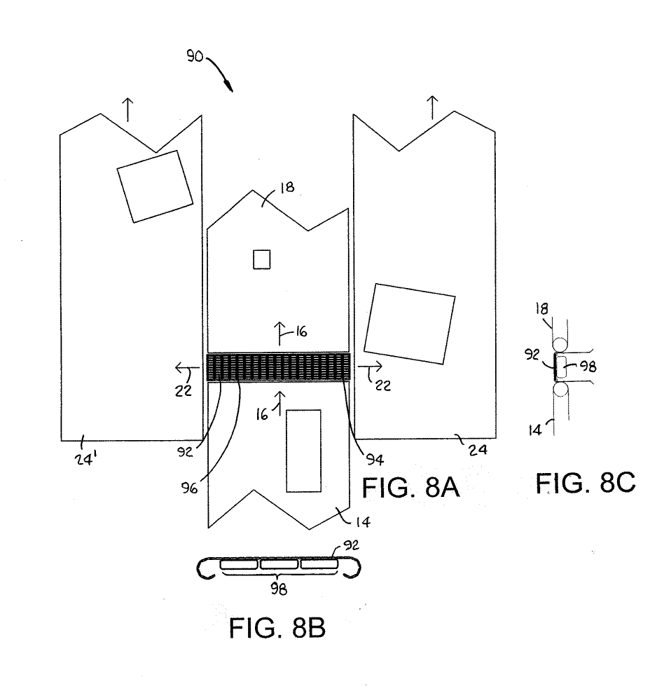

Another version of a diverting conveyor embodying features of the invention is shown in FIGS. 8A-8C. The diverting conveyor 90 has article-supporting belt rollers 92 that include electrically conductive or magnetic material. The rollers protrude from the top face 94 of a diverting conveyor belt 96. The rollers shown are elongated perpendicular to the conveying direction 16 more than the belt rollers 30 in FIG. 1, which could alternatively include electrically conductive or magnetic material and be used. The rollers 92 rotate on axles providing axes of rotation perpendicular to the conveying direction 16. A linear-motor stator 98 is mounted below the top run of the diverting conveyor belt 96 between the infeed portion 14 and the outfeed portion 18. The stator 98 propagates an electromagnetic wave through the conveyor belt 96 parallel to the conveying direction 16 that induces currents in rollers 92 that include electrically conductive material. The induced currents create a secondary electromagnetic field that interacts with the stator wave to produce a force that actuates the rollers 92 to rotate in the conveying direction 16. Thus, the electrically conductive rollers 92 each form a linear-induction motor with the stator 98. Rollers 92 that include magnetic material create magnetic fields that interact with the stator wave to produce a force that actuates the rollers to rotate in the conveying direction. Thus, the magnetic rollers 92 each form a linear-synchronous motor with the stator 98. In either case, when the conveyor belt 96 is stopped to allow an article to transfer across from the infeed portion 14 to the outfeed portion 18 without being diverted, the rollers 92 are actuated to aid the transfer and prevent stranding. Sensors and the tilt actuator of FIGS. 1-5B may be used with the diverting conveyor of FIGS. 8A-8C. And the conveyor belt may be operated bidirectionally in opposite diverting directions 22 to divert articles onto discharge conveyors 24, 24′ on either side.

A block diagram of a control system for a diverting conveyor as in FIG. 1 or FIGS. 8A-8C is shown in FIG. 6. A controller 76, such as a programmable logic controller or other programmable computing device receives a sensor input signal or signals 78 from one or more sensors, such as one or more of the position sensors 28 or a barcode reader or other indicia-reading sensor 79, on the upstream conveyor portion. From the sensor signal or signals, the controller 76 determines a characteristic of the article, such as the leading edge, length, size, shape, or identity of the article passing the sensor's sensing position. With knowledge of the sensor's sensing position along the length of the conveyor line, the controller 76 knows the position of the article at the time the sensor signal is received. The system may also use another position sensor 89 mounted at the diverting belt to send a signal 88 indicating the presence of an article entering or about to enter the diverting belt. From the characteristic information provided by the sensor or sensors 28, 79, 89 the controller 76 decides whether the article should pass through or should be diverted from the conveyor line. The controller 76 controls the run speed (and direction if a bidirectional motor is used) of the roller belt with a diverting motor signal 80 to the belt's motor 60. The controller 76 controls the tilting of the roller belt by sending a tilt signal 82 to the tilt actuator's servomotor 64. For the conveyor of FIGS. 8A-8C, the controller 76 controls the linear motor stator 98 to actuate or deactuate the belt rollers with a linear-motor signal 99. And the controller 76 may also be used to control the speed of the main conveying line with a conveyor motor signal 84 to the conveyor-line motor or motors 86.

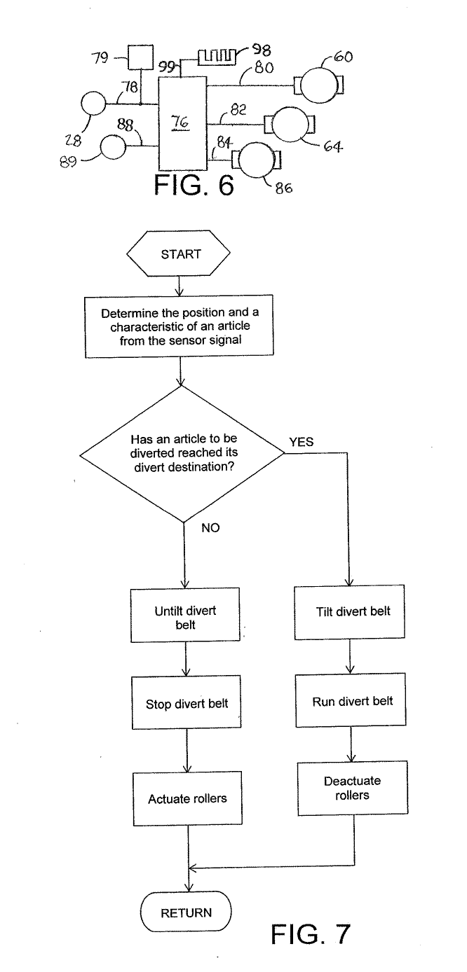

The controller 76 is programmed to operate the diverting conveyor according to the exemplary flowchart of FIG. 7. First, the controller determines the position and a characteristic, such as the length, shape, or identity of an article on the upstream infeed conveyor portion of the conveyor line from the sensor signal. From the characteristic of the article, the controller decides whether the article is to be diverted or passed through. In a system with more than one diverting conveyor belt along the length of the line, the controller determines the divert destination of each article to be diverted and allows it to pass through all divert locations upstream of the divert destination. With knowledge of the speed of the infeed conveyor, the controller can estimate the article's arrival time at the diverting belt. Alternatively, a position sensor near the entrance to the diverting belt can be used to signal the controller of the impending entrance of the article onto the diverting belt. The upstream sensor may include a barcode reader or an optical sensor, such as a laser sensor or a visioning system, or both. If a visioning system or a multi-sensor optical or laser system is used, the computed size will include information on the article's shape.

If, upon reaching a divert location, the article is to be passed through, the controller stops the diverting conveyor belt with the motor signal 80 to the diverting belt's motor 60 (FIG. 6). And the controller untilts the diverting belt by sending an untilt command in the tilt signal 82 to the tilt actuator 64 (FIG. 6) to return the diverting conveyor belt to the untilted first position. For the linear-motor conveyor of FIGS. 8A-8B, the controller actuates the rollers 92 by powering the stator 98 to transfer the articles across the belt. The acceptable article then passes over the roller-top belt and onto the downstream outfeed conveyor.

If, on the other hand, the article to be diverted reaches its divert destination, the controller sends a tilt command in the tilt signal to the tilt actuator to tilt the diverting conveyor belt to the tilted second position and a run command in the motor signal to the diverting belt's motor to advance the belt toward the discharge conveyor. And for the conveyor of FIGS. 8A-8C, the controller deactuates the rollers 92 by unpowering the stator 98.

The controller's control software routine described by the flowchart of FIG. 7 resides in the controller's program memory and runs whenever an article is detected at the sensor's position on the upstream infeed conveyor. Or the individual blocks may be divided into individual tasks or interrupt routines that run on different schedules as determined by a task manager and interrupt handler in the controller software.

The tilting of the diverting conveyor belt 20 shown in FIG. 5B does not raise the upstream edge 48 of the diverting belt above the plane of the infeed conveyor 14. As shown the upstream edge 48 is at the same level whether the diverting belt 20 is in the tilted or the untilted position. Because of that, the articles, which are typically singulated and spaced apart along the length of the infeed conveyor 14, are not blocked from advancing onto the diverting belt 20 as they would be if the diverting belt were merely lifted vertically. So the timing of the tilting of the diverting belt is not critical as with a diverting belt that lifts vertically.

Although the invention has been described by reference to an exemplary version, other versions are possible. For example, the tilt actuator could be realized instead with a linear actuator powered by hydraulics, pneumatics, or electromagnetics or with a gear system, such as a rack-and-pinion system. As another example, if the diverting conveyor belt is narrow enough, i.e., narrower than the length of the conveyed articles, it could be a belt with a rollerless, low-friction, flat top surface across which pass-through articles can slide easily.

What is claimed is:

1. A conveyor system comprising:
a main conveyor line having an infeed portion and an outfeed portion and conveying articles in a conveying direction;
a diverting conveyor belt intersecting the main conveyor line between the infeed portion and the outfeed portion and advanceable in a diverting direction transverse to the conveying direction, the diverting conveyor belt including:
an upstream edge adjacent the infeed portion, an opposite downstream edge adjacent the outfeed portion, and an outer side;
a plurality of article-supporting rollers protruding from the outer side and including electrically conductive or magnetic material and arranged to rotate in the conveying direction;
a linear-motor stator disposed under the diverting conveyor belt producing an electromagnetic wave that interacts with the rollers to actuate the rollers to rotate in the conveying direction;
a controller selectively:
(a) advancing the diverting conveyor belt in the diverting direction and unpowering the linear-motor stator to deactuate the rollers to divert articles from the main conveyor line; and
(b) stopping the diverting conveyor belt and powering the linear-motor stator to actuate the rollers to rotate in the conveying direction to transfer articles across the diverting conveyor belt from the infeed portion to the outfeed portion.

2. A conveyor system as in claim 1 comprising an actuator selectively tilting the diverting conveyor belt between a first position in which the diverting conveyor belt is not tilted relative to the infeed portion of the main conveyor line to allow articles to pass from the infeed portion to the outfeed portion across the diverting conveyor belt and a second position in which the downstream edge of the diverting conveyor belt is tilted higher than the upstream edge to divert articles received from the infeed portion in the diverting direction.

3. A conveyor system as in claim 2 comprising one or more sensors disposed along the main conveyor line upstream of the diverting conveyor belt and producing one or more sensor signals indicative of the presence of an article and a characteristic of the article and wherein the controller receives the one or more sensor signals and determines from the one or more sensor signals a characteristic and a position of the article on the main conveyor and enables the actuator to tilt the diverting conveyor belt to the tilted second position, disables the linear-motor stator, and advances the diverting conveyor belt in the diverting direction to divert an article if the controller determines from the characteristic that the article is to be diverted by the diverting conveyor belt.

4. A conveyor system as in claim 3 wherein the characteristic is selected from the group consisting of the article's size, shape, length, leading edge, and identity.

5. A conveyor system as in claim 2 comprising one or more sensors disposed along the main conveyor line upstream of the diverting conveyor belt and producing one or more sensor signals indicative of the presence of an article and a characteristic of the article and wherein the controller receives the one or more sensor signals and determines from the one or more sensor signals a characteristic and a position of the article on the main conveyor line and disables the actuator to move the diverting conveyor belt to the untilted first position, enables the linear-motor stator to actuate the rollers to rotate in the conveying direction, and stops the diverting conveyor belt to transfer an article across the diverting conveyor belt from the infeed portion to the outfeed portion if the controller determines from the characteristic that the article is not to be diverted by the diverting conveyor belt.

6. A conveyor system as in claim 5 wherein the characteristic is selected from the group consisting of the article's size, shape, length, leading edge, and identity.

7. A conveyor system as in claim 1 wherein the plurality of rollers have axles defining axes of rotation parallel to the diverting direction.

8. A conveyor system as in claim 1 wherein the diverting conveyor belt is narrower than the lengths of the articles in the conveying direction.

9. A conveyor system as in claim 1 wherein the diverting direction is perpendicular to the conveying direction.

10. A conveyor system as in claim 1 wherein the upstream edge of the diverting conveyer belt is at the same level in the first and second positions of the diverting conveyor belt.
